(19) United States
(12) Patent Application Publication
(10) Pub. No.: US 2012/0174174 A1
(43) Pub. Date: Jul. 5, 2012

(54) DELIVERY SYSTEM, GATEWAY, DELIVERY METHOD, AND PROGRAM

(76) Inventor: Kazunori Ozawa, Tokyo (JP)

(21) Appl. No.: 13/395,116

(22) PCT Filed: Sep. 9, 2010
(86) PCT No.: PCT/JP2010/065480

§ 371 Date: Mar. 8, 2012

(30) Foreign Application Priority Data
Sep. 14, 2009 (JP) 2009-212222
Sep. 14, 2009 (JP) 2009-212223

(51) Int. Cl. H04N 21/60

(52) U.S. Cl. 725/110

(57) ABSTRACT

A delivery system includes a content conversion device including a capability information recording unit that associates and records terminal unit type information included in a content request message with capability information regarding the capability of a terminal to receive hierarchically encoded data; a receiver that receives a stream or file compression-encoded by means of a hierarchical encoding method based on the content request message; an alteration instructing unit that, based on the terminal capability information corresponding to the terminal unit type information included in the content request message, produces extraction information for extracting at least one hierarchically-encoded portion from the received stream or file; a converter that, in accordance with the extraction information, converts stream or file received from the request destination; and a packet transmitter that outputs the converted stream or file.

### DESCRIPTION OF RELATED APPLICATION

The present invention is based upon and claims the benefit of the priority of Japanese patent applications No. 2009-212222 filed on Sep. 14, 2009 and No. 2009-212223 filed on Sep. 14, 2009, the disclosures of which are incorporated herein in their entirety by reference thereto.

### TECHNICAL FIELD

The present invention relates to a delivery system, gateway, delivery method, and program, and particularly to a delivery system, gateway, delivery method, and program delivering contents compression-encoded by means of a hierarchical encoding method.

### BACKGROUND ART

As more fixed networks become broadband or NGNs (Next Generation Network) and the speed and capacity of mobile networks increase, content delivery in which contents including images (still image, video, etc.) and audio are delivered to set-top box and television in home via these networks is becoming popular. Further, services taking advantage of the merits of NGNs such as IPTV (Internet Protocol Television) will be started in the near future.

Moreover, the speed and capacity of mobile networks will increase due to technologies such as LTE (Long Term Evolution) and EPC (Evolved Packet Core).

Patent Document 1 discloses a server/client system comprising a server executing processing of transmitting hierarchically encoded data and a client receiving hierarchically encoded data from the server. According to the document, the client executes processing of storing requested data aspect identifying information showing the aspect of hierarchically encoded data requested by the client in a data request message transmitted to the server and of transmitting the message, and based on the requested data aspect identifying information included in the data request message received from the client, the server extracts encoded data corresponding to the requested data aspect identifying information from a storage unit or generates the data, and executes processing of transmitting the data to the client.

Patent Document 2 discloses an image transmission apparatus in which decoding capability information of all image receiving apparatuses in the system is registered in a configuration management table, a parameter setting section of the image transmission apparatus reads decoding capability information of an image receiving apparatus at an image transfer destination from the configuration management table, and parameters of a coding processing section are set according to this decoding capability information.

Patent Document 3 is another example of a hierarchical coding video distribution system. A gateway of Patent Document 3 receives each second video stream using m sets of first multicast channels, integrates and processes m sets of the second video streams into third video streams for n sets of user terminals based on desired integral hierarchy numbers submitted by user terminals, and distribute them.

Patent Document 4 is yet another example of a hierarchical coding video distribution system. A gateway of Patent Document 3 receives each second video stream using m sets of first multicast channels, integrates and processes m sets of the second video streams into third video streams for n sets of user terminals based on desired integral hierarchy numbers submitted by user terminals, and distribute them.

Further, Patent Document 5 discloses an image transmitter capable of transmitting an image by dynamically changing the scalability in accordance with the congested traffic of a communication path.

### PRIOR ART DOCUMENT

### Patent Document

### [Patent Document 1]

Japanese Patent Kokai Publication No. JP2004-192140A

### [Patent Document 2]

Japanese Patent Kokai Publication No. JP2005-101677A

### [Patent Document 3]

Japanese Patent Kokai Publication No. JP2001-352533A

### [Patent Document 4]

Japanese Patent Kokai Publication No. JP2007-281640A

### [Patent Document 5]

Japanese Patent Kokai Publication No. JP2004-166156A

### DISCLOSURE OF THE INVENTION

### Problems to be Solved by the Invention

The disclosures of Patent Documents 1 to 5 are incorporated herein in their entirety by reference thereto. The following analysis is given by the present invention.

In the current services, however, only household set-top box, and television and DVD recorder connected thereto are able to receive the delivery of contents compression-encoded using a hierarchical encoding method for TV. Various terminals not connected to the device above (for instance, PC (personal computer), game device, digital photo frame etc.) cannot receive the delivery, much less mobile terminals such as a mobile telephone that is not capable of connecting to the device to receive the delivery of contents for TV outside the home.

One of the reasons is that, when the various terminals and the mobile telephone mentioned above try to receive, decode, and display image and audio contents, encoding information used when the contents were encoded and the capability information of these terminals do not match. As a result, these terminals have trouble decoding video stream, and the video may not get displayed or the picture may get distorted.

Further, another reason is that the bit rate, resolution, codec, file format, or protocol does not match. In this case, the terminals are not able to even decode the contents.

As measures to avoid these problems, contents may be converted or processed in advance to prepare contents suitable for each type of terminal such as a version for TV, PC, or mobile devices, or this conversion/processing may be performed in response to a request from a terminal. In these measures, however, enormous efforts and costs may be required since a lot of work is demanded as contents and the types of terminals increase.

The server/client system of Patent Document 1 needs to store the requested data aspect identifying information showing the aspect of hierarchically encoded data requested by a client in a request message from the client to the server, and transmit it. In order to store special information such as the requested data aspect identifying information, a conventional client cannot be used as it is. Therefore, a client has to be modified, or a new client capable of storing the requested data aspect identifying information must be brought in.

For the image transmission apparatus of Patent Document 2, the decoding capability information of every image receiving apparatuses in the system must be prepared, and there may be cases where a terminal not having the decoding capability information thereof registered in the image transmission apparatus is unable to perform decoding as described above.

The present invention has been made considering the circumstances above, and it is an object thereof to provide a delivery system, gateway, delivery method, and program delivering contents assumed to be delivered for TV in such a manner that a variety terminals are able to view the contents without requiring modification of the terminals or processing of the contents.

### Means to Solve the Problems

According to a first aspect of the present invention, there is provided a delivery system including a content conversion device comprising a capability information recording unit that associates and records terminal unit type information included in a content request message with capability information regarding the capability of a terminal to receive hierarchically encoded data; a receiver that receives a stream or file compression-encoded by means of a hierarchical encoding method based on the content request message; an alteration instructing unit that creates extraction information for extracting at least one hierarchically encoded portion from the received stream or file based on the terminal capability information corresponding to the terminal unit type information included in a content request message; a converter that converts the stream or file received from the request destination according to the extraction information; and a packet transmitter that transmits the converted stream or file.

According to a second aspect of the present invention, there is provided a content conversion device comprising a capability information recording unit that associates and records terminal unit type information included in a content request message with capability information regarding the capability of a terminal to receive hierarchically encoded data; a receiver that receives a stream or file compression-encoded by means of a hierarchical encoding method based on the content request message; an alteration instructing unit that creates extraction formation for extracting at least one hierarchically encoded portion from the received stream or file based on the terminal capability information corresponding to the terminal unit type information included in a content request message; a converter that converts the stream or file received from the request destination according to the extraction information; and a packet transmitter that transmits the converted stream or file.

According to a third aspect of the present invention, there is provided a delivery method including a step of receiving a stream or file compression-encoded by means of a hierarchical encoding method based on a content request message; a step of creating extraction information for extracting at least one hierarchically encoded portion from the received stream or file based on capability information regarding the capability of a terminal to receive hierarchically encoded data derived from unit type information of the terminal included in a content request message; a step of converting the stream or file received from the request destination according to the extraction information; and a step of delivering the converted stream or file to the transmission source of the content request message. The present method is tied to a particular machine, which is a computer converting contents and delivering them to a terminal in response to an external request.

According to a fourth aspect of the present invention, there is provided a program executed by a computer converting content delivered to a terminal in response to an external request and having the computer execute a process of receiving a stream or file compression-encoded by means of a hierarchical encoding method from a content delivery source based on a content request message from the terminal; a process of creating extraction information for extracting at least one hierarchically encoded portion from the received stream or file based on capability information regarding the capability of a terminal to receive hierarchically encoded data derived from unit type information of the terminal included in the content request message; a process of converting the stream or file received from the request destination according to the extraction information; and a process of outputting the converted stream or file. Further, this program may be stored in a storage medium readable by a computer. In other words, the present invention can be embodied as a computer program product.

### Effect of the Invention

According to the present invention, it becomes possible to deliver contents to a variety of terminals ranging from mobile telephones to televisions without changing the specifications of the terminals and converting the contents in advance. The reason is that a configuration including a content conversion device that creates a stream including a plurality of hierarchically encoded portions by means of a hierarchical encoding method such as H.264/AVC SVC and that converts content according to terminal unit type information included in a content request message from these terminals is employed.

### BRIEF DESCRIPTION OF THE DRAWINGS

FIG. 1 is a block diagram illustrating the connection configuration of a first exemplary embodiment of the present invention.

FIG. 2 is a block diagram illustrating a detailed configuration of a gateway of the first exemplary embodiment of the present invention.

FIG. 3 is a block diagram illustrating the connection configuration of a second exemplary embodiment of the present invention.

FIG. 4 is a block diagram illustrating the connection configuration of a third exemplary embodiment of the present invention.

FIG. 5 is a block diagram illustrating the connection configuration of a fourth exemplary embodiment of the present invention.

FIG. 6 is a block diagram illustrating another configuration example of the gateway of the present invention.

FIG. 7 is a block illustrating a detailed configuration of a gateway of fifth exemplary embodiment of the present invention.

FIG. 8 is a block diagram illustrating yet another configuration example of the gateway of the present invention.

### PREFERRED MODES FOR CARRYING OUT THE INVENTION

First, a summary of the present invention will be given. A stream or file compression-encoded using a predetermined hierarchical encoding method is prepared. Here, hierarchical encoding means that a source signal is divided into a plurality of hierarchies and each hierarchy is encoded.

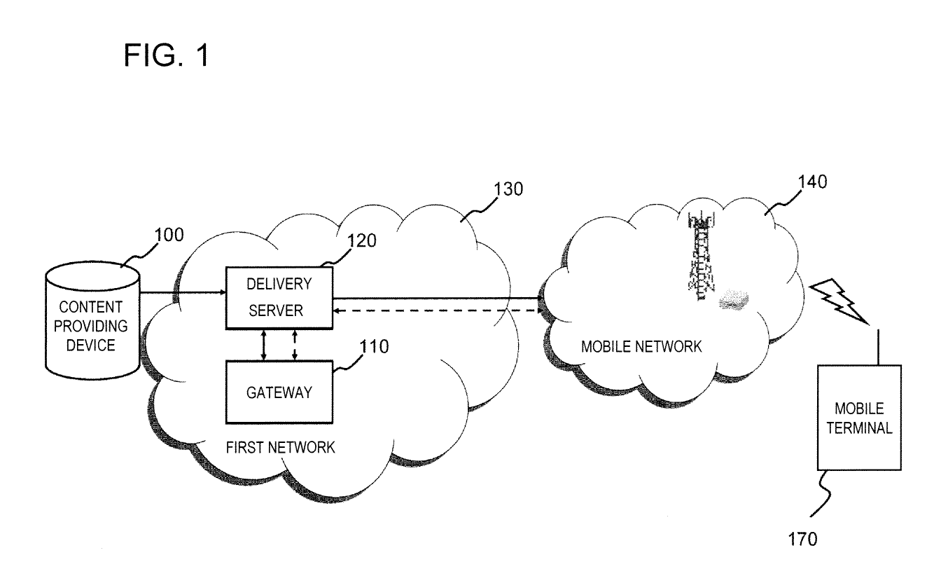

A content conversion device (corresponding to a gateway 110 in FIG. 1) comprises a capability information recording unit that records capability information regarding the capability of a terminal to receive hierarchically encoded data for each terminal type; an alteration instructing unit that creates extraction information for extracting at least one hierarchically encoded portion from the received stream or file so as to become compatible with the capability information of the terminal; and a converter that converts the stream or file received from the request destination according to the extraction information.

The content conversion device receives the compression-encoded stream or file requested by a content request message and a terminal via a delivery server 120 receiving a content request message from various types of terminals (a mobile terminal 170 in FIG. 1 is an example of the terminal). The content conversion device (corresponding to the gateway 110 in FIG. 1) reads the capability information of the terminal, which requested the delivery of the content, from the capability information recording unit using terminal unit type information included in the content request message. Then, the content conversion device (corresponding to the gateway 110 in FIG. 1) creates the extraction information for extracting at least one hierarchically encoded portion from the received stream or file based on the read capability information. Next, according to the extraction information, the content conversion device (corresponding to the gateway 110 in FIG. 1) extracts a hierarchically encoded portion from the stream or file received from the request destination, and performs conversion corresponding to the capability of the terminal. The converted stream or file is delivered to the requesting terminal (corresponding to the mobile terminal 170 in FIG. 1), for instance, via the delivery server 120.

With the configuration above, it becomes possible to deliver contents to a variety of terminals from mobile telephones to televisions without changing the specifications of the terminals or converting the contents beforehand. Further, as necessary, the protocol or file format can be converted after at least one hierarchically encoded portion has been extracted from the compression-encoded stream or file.

### Exemplary Embodiment 1

Next, a first exemplary embodiment of the present invention will be described in detail with reference to the drawings. It should be noted that, although the explanation will be made assuming that a video is delivered as content in the exemplary embodiments below, the same configuration can be applied to other contents such as still images, audio, and sound contents.

FIG. 1 is a block diagram illustrating the connection configuration of the first exemplary embodiment of the present invention. FIG. 1 shows a content providing device 100, the delivery server 120 connected to the gateway 110, and the mobile terminal 170. Solid arrows in FIG. 1 indicate data flows and broken arrows indicate control signal flows.

The content providing device 100 stores a bit stream or file storing a bit stream obtained by compression-encoding content including at least one of a video, still image, audio and voice by means of a hierarchical encoding method. In the present exemplary embodiment, H.264/AVC SVC (Scalable Video Coding) is used as a hierarchical encoding method for video contents. One can refer to the H.264/AVC Annex G standard in ITU-T and ISO EC for details.

A first network 130 may be any of the following networks: IP (Internet Protocol) network, broadband network, NGN (Next Generation Network), and the Internet network.

A mobile network 140 may be any of the following networks: mobile packet network, WiMax (Worldwide Interoperability for Microwave Access) network, and LTE (Long Term Evolution) network. We will assume here that it is a mobile packet network.

Upon receiving a connection request from the mobile terminal 170 via the mobile network 140, the delivery server 120 acquires the terminal unit type information of the mobile terminal included in a connection request protocol and outputs the information to the gateway 110. Here, as the connection request protocol, HTTP (Hyper Text Transfer Protocol) is used, but other protocols such as SIP (Session Initiation Protocol) may be used.

After acquiring the terminal unit type information, the delivery server 120 acquires information of content selected by the mobile terminal 170, reads a stream or file, compression-encoded with H.264/SVC, of the selected content from the content providing device 100, and outputs the stream or file to the gateway 110. Further, the delivery server 120 sends capability information (for instance, the codec used when the content was compression-encoded, the screen resolution of the image, bit rate, frame rate, information indicating whether the content is a stream or file, etc.) of the selected content itself to the gateway 110 using a protocol such as SDP (Session Description Protocol). Further, the delivery server 120 delivers an output packet from the gateway 110 to the mobile terminal 170 via a network.

The gate ay 110 receives the H.264/AVC compressed stream or file and the terminal unit type information of the mobile terminal 170 the delivery server 120, ex tracts at least one hierarchically encoded portion from the stream or the stream stored in the file according to the capability of the mobile terminal 170, and sends the extracted portion to the mobile terminal 170 via the delivery server 120. In other words, the gateway 110 functions as the content conversion device converting content according to the terminal unit type information of the mobile terminal 170.

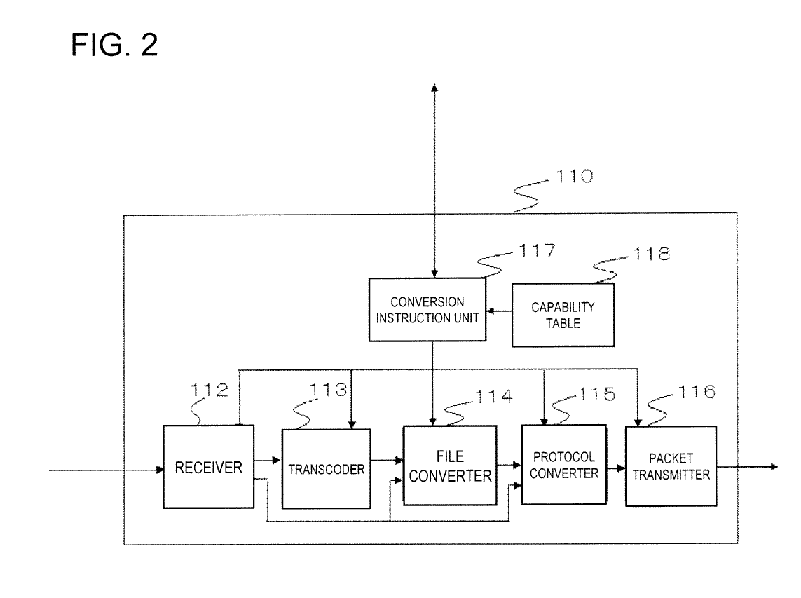

FIG. 2 is a block diagram illustrating a detailed configuration of the gate way 110 functioning as the content conversion de vice. With reference to FIG. 2, the gateway 110 comprises a receiver 112, a transcoder 113, a file converter 114, a protocol converter 115, a packet transmitter 116, a conversion instruction unit 117, and a capability table 118 corresponding to the capability information recording unit described above.

From the mobile terminal 170, the conversion instruction unit 117 receives a content request message using a particular protocol and terminal unit type information via the delivery server 120. For instance, in a case of HTTP, terminal unit type information described in the User Agent header can be obtained. In addition, the conversion instruction unit 117 may acquire information (for instance, the type of the network, the bandwidth, etc.) of the network used for the connection. Further, other known protocols such as SDP (Session Description Protocol) may be used.

The following capability information for each type of terminal is held in the capability table 118 in advance.
(1) Receivable codec
(2) Possibility of receiving hierarchically encoded stream or file (yes or no)
(3-1) Receivable level of hierarchically encoded stream (when it is possible to receive hierarchically encoded stream or file)
(3-2) Receivable resolution, hit rate, frame rate (when it is not possible to receive hierarchically encoded stream or file)
(4) Receivable protocol
(5) Receivable file format and file size
   Information other than (1) to (5) above may be added to the capability information.

Based on the capability information corresponding to the terminal unit type information read from the capability table 118 above and the capability information (for instance, the codec used when the content was compression-encoded, the screen resolution of the video, hit rate, frame rate, information indicating whether the content is a stream or file, etc.) of the content sent by the delivery server 120, the conversion instruction unit 117 creates extraction information indicating whether or not the video content received from the delivery server 120 needs to be converted, and what kind of conversion is performed by the transcoder 113 when conversion is necessary.

For instance, we will assume that the capability information of the content indicates a case where video content is compression-encoded with H.264/AVC SVC at 10 Mbps having a single Basement Layer, N layers of Enhancement Layers (N is an integer equal to or greater than 1), a maximum resolution of 1440×1080 pixels (HD) with a frame rate of 30 fps, and a minimum resolution of 176×144 (QCIF) with a frame rate of 15 fps.

For instance, we will further assume that the mobile terminal 170 is a new type of mobile telephone and the capability information indicating H.264/AVC SVC encoding at 512 kbps, a screen resolution of QVGA 320×240 pixels), and a frame rate of 30 fps is obtained from the capability table 118.

In this case, the conversion instruction unit 117 creates the extraction information (for instance, converting the screen resolution from HD to QVGA by taking t the Basement Layer bit stream and Enhancement Layer 1 from the H.264/AVC SVC bit stream and converting the bit rate and frame rate to 512 kbps and 30 fps, respectively) for extracting at least one hierarchically encoded portion from the H.264/AVC SVC bit stream so that the selected content becomes compatible with the capability information of the terminal at a delivery destination, and output this extraction information to the transcoder 113. Further, the read capability information is outputted to the receiver 112, the file converter 114, the protocol converter 115, and the packet transmitter 116.

Further, for instance, in a case where the capability information indicates that the terminal unit type information of the mobile terminal 170 indicates an old model, H.264/AVC SVC encoding cannot be decoded, and only MPEG-4 baseband Profile (128 kbps, 15 fps) can be decoded, the conversion instruction unit 117 outputs information instructing to extract only Basement Layer from the H.264/AVC SVC stream and convert the codec of this into MPEG-4 Baseband Profile (128 kbps, 15 fps) to the transcoder 113 as the extraction information and the conversion information. Further, the read capability information is outputted to the receiver 112, the file converter 114, the protocol converter 115, and the packet transmitter 116.

The receiver 112 receives the file or stream of the selected video content from the delivery server 120, extracts the stream stored in the file when it is a file, and outputs the stream. When it is a stream, the receiver 112 extracts a stream stored in the payload of a packet and outputs the stream to the transcoder 113.

The transcoder 113 receives the stream extracted by the receiver 112, has the transcoder, which operates in real time, operate according to the extraction information (for instance, taking out the Basement Layer hit stream and Enhancement Layer1 from the H.264/AVC SVC bit stream) outputted from the conversion instruction unit 117, extracts at least one hierarchically encoded portion from the H.264/AVC SVC stream, and outputs the extracted stream to the file converter 114.

Meanwhile, when the codec must be converted in the case of an old mobile terminal model, the conversion information is outputted, in addition to the extraction information. In this case, the transcoder 113 extracts, for instance, only Basement Layer from the H.264/AVC SVC stream according to the extraction information, performs codec conversion in which Basement Layer converted into MPEG-4 Baseband Profile (128 kbps, 15 fps), and outputs the converted stream to the file converter 114.

The file converter 114 converts the file format of the extracted stream outputted from the transcoder 113 into a file format to be sent to the mobile terminal 170 according to “(5) Receivable file format and file size” of the capability information of the mobile terminal 170 outputted from the conversion instruction unit 117. For instance, file formats of mobile terminals are 3GPP, 3GPP2, and MP4, and the file format can be determined depending on the model of the mobile terminal. The file converter 114 generates a file according to the file format determined as described, stores the extracted stream therein, and outputs the file to the protocol converter 115. As for the details of the 3GPP file format, one can refer to the 3GPP TS 26.244 standard.

The protocol converter 115 determines a protocol receivable by the mobile terminal 170 according to “(4) Receivable protocol” of the capability information outputted from the conversion instruction unit 117, and sends the file outputted from the file converter 114 via this protocol. Here, HTTP is used as the protocol, however, other known protocols such as RTP (Real time Transport Protocol) may be used.

The packet transmitter 116 sends the file outputted from the protocol converter 115 as an HTTP/UDP/IP packet to the mobile network 140 according to the capability information outputted from the conversion instruction unit 117. Here, other known packet formats such as the RTP/UDP/IP packet may be used as the packet format used by the packet transmitter 116 to send the packet.

In the first exemplary embodiment of the present invention described above, the mobile network 140 may be a WiMax network or LTE network, instead of a mobile packet network, and the same configuration can be used. Further, a network using a femtocell access point may be used with the same configuration as well.

Further, in the exemplary embodiment described above, 3GPP, 3GPP2, and MP4 are cited as examples of the conversion destination file format of the file converter 114, however, other file formats may be used.

Further, in the exemplary embodiment described above, HTTP and RTP are cited as examples of the conversion destination protocol of the protocol converter 115, however, other protocols may be used.

Further, in the exemplary embodiment described above, the content obtained by compression-encoding a video signal is delivered, however, the same configuration may be applied to contents such as still images, audio signals, and voice signals.

### Exemplary Embodiment 2

Next, a second exemplary embodiment of the present invention in which changes are made to the delivery destination of content will be described in detail with reference to the drawings.

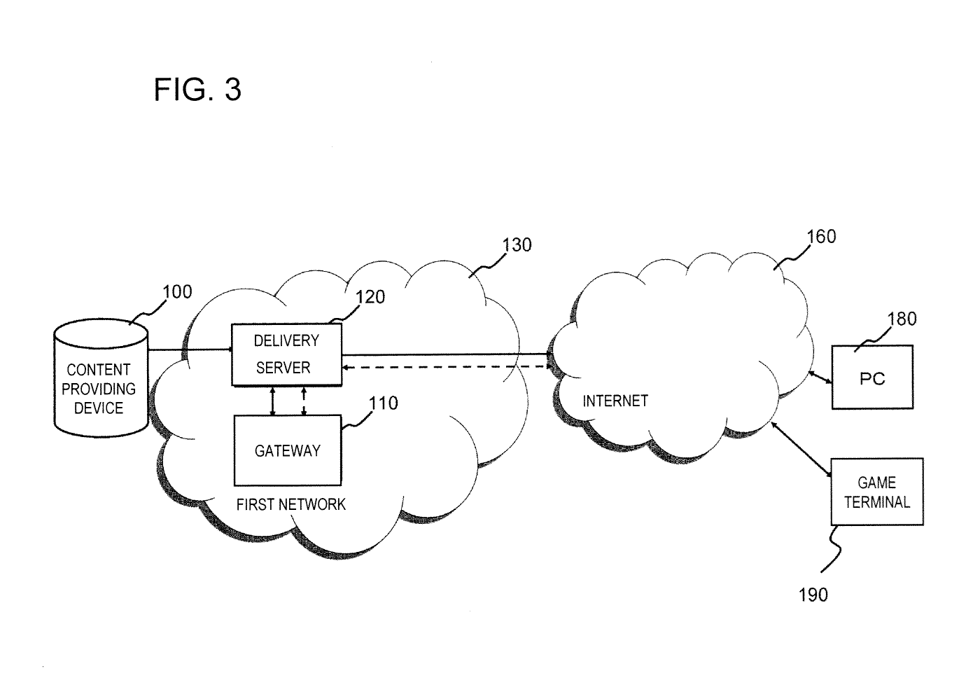

FIG. 3 is a block diagram illustrating the connection configuration of the second exemplary embodiment of the present invention. In FIG. 3, constituent elements given the same numbers as those in FIG. 1 are the same constituent elements as those in the first exemplary embodiment; therefore explanations of them will be omitted and differences will be described below.

In FIG. 3, a PC (personal computer) 180 and a game terminal 190 are connected to the delivery server 120 via the Internet 160. It should be noted that, although the PC 180 and the game terminal 190 are shown in the example of FIG. 3, other devices having an Internet connection function such as a digital photo frame, a note PC storing a mobile data card, and a mobile data card can be the delivery destination by registering the terminal unit type information in the capability table.

The PC 180 and the game terminal 190 sends a connection request signal to the delivery server 120 via the Internet 160 using a particular protocol (for instance, HTTP). Since exchanges between the delivery server 120 and the gateway 110 thereafter are the same as in the first exemplary embodiment, explanation will be omitted.

### Exemplary Embodiment 3

Next, a third exemplary embodiment of the present invention in which changes are made to the delivery destination of content will be described in detail with reference to the drawings.

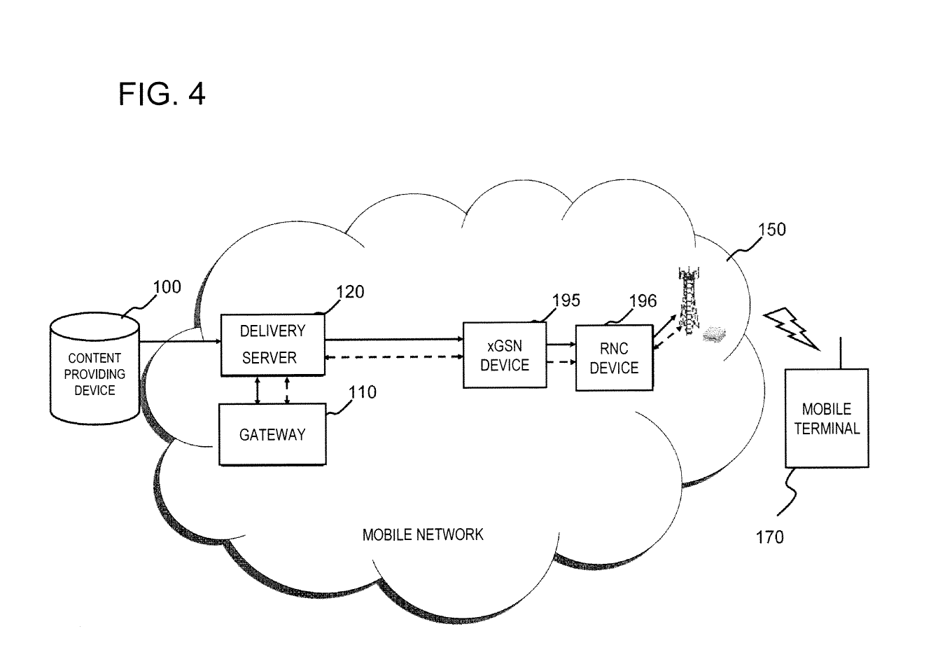

FIG. 4 is a block diagram illustrating the connection configuration of the third exemplary embodiment of the present invention. In FIG. 4, constituent elements given the same numbers as those in FIG. 1 are the same constituent elements as those in the first exemplary embodiment; therefore explanations of them will be omitted and differences will be described below.

In a mobile network 150 in FIG. 4, an xGSN (Serving/Gateway GPRS Support Node) device 195 and an RNC (Radio Network Controller) device 196 are disposed. Note that GPRS stands for General Packet Radio Service, which realizes high-speed packet communication.

As the protocol between the delivery server 120 and the xGSN device 195, GTP (GPRS Tunneling Protocol) is used. Therefore, the protocol converter 115 of the gateway 110 reads the file format with the GTP/UDP/IP protocol, and the packet transmitter 116 sends a GTP/UDP/IP packet to the xGSN device 195 on the mobile network 150 via the delivery server 120.

The xGSN device 195 converts the protocol of the file outputted from the delivery server 120 into the Iu-PS protocol and outputs the file to the RNC device 196. The RNC device 196 converts the Iu-PS protocol into the TCP/IP protocol, selects a radio base station in a service area of the mobile terminal 170, and sends a packet to the mobile terminal 170 via this radio base station.

The mobile terminal 170 receives the content file using the TCP/IP protocol via the mobile network 150, extracts a stream from the file, decodes, plays back, and displays it.

Further, as the wireless function of the mobile terminal 170, HSDPA (High Speed Downlink Packet Access), HSPA+ (High Speed Packet Access), LTE (Long Term Evolution), and WiMax may be used, in addition to W-CDMA (Wideband Code Division Multiple Access) and CDMA 2000.

### Exemplary Embodiment 4

Next, a fourth exemplary embodiment of the present invention in which changes are made to the delivery destination of content will be described in detail with reference to the drawings.)

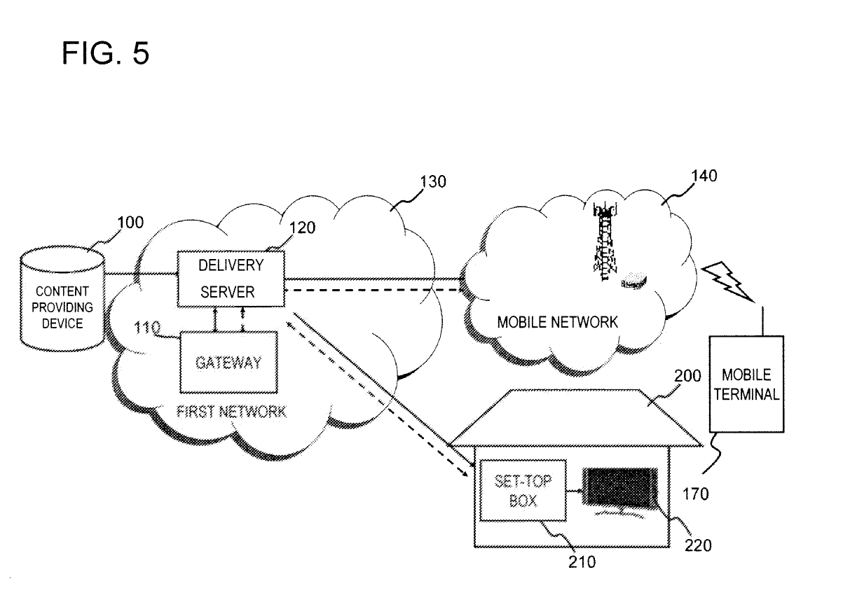

FIG. 5 is a block diagram illustrating the connection configuration of the fourth exemplary embodiment of the present invention. In FIG. 5, constituent elements given the same numbers as those in FIG. 1 are the same constituent elements as those in the first exemplary embodiment; therefore explanations of them will be omitted and differences will be described below.

In FIG. 5, the first network 130 is an NGN.

The delivery server 120 receives a request from the mobile terminal 170 via the mobile network 140. Further, the delivery server 120 receives a request from a television 220 in a home 200 through a set-top box 210.

The delivery server 120 reads the terminal unit type information from the request message sent by the mobile terminal 170 or the television 220 and informs the gateway 110.

Since the set-top box 210 and the television 220 are able to receive and play back a video stream with HD resolution and a frame rate of 30 fps, the extraction information indicating that all the hierarchically encoded portions of the H.246/AVC SVC should be extracted is obtained after the capability information corresponding to the terminal unit type information has been acquired from the capability table 118. As a result, the stream extracted by the receiver 112 is outputted to the protocol converter 115, bypassing the transcoder 113 and the file converter 114.

The protocol converter 15 uses the UPnP/IP protocol defined by DLNA (Digital Living Network Alliance), and the packet transmitter 116 stores the protocol in a packet and sends the packet to the set-top box 210 via the NGN.

Meanwhile, as for the delivery to the mobile network 140, the gateway 110 performs the extraction and conversion using an estimated value of the bandwidth of the mobile network and the terminal unit type information, as in the first exemplary embodiment.

As evident in the present exemplary embodiment, the content delivery to TV via the NGN and the content delivery to the mobile terminal 170 via the mobile network 140 can be performed with the same configuration in the present invention.

### Summary of Exemplary Embodiment 5

Next, a summary of a fifth exemplary embodiment of the present invention will be described. A content conversion device (corresponding to the gateway 110 in FIG. 1) of the present exemplary embodiment comprises a capability information recording unit that records capability information regarding the capability of a terminal to receive hierarchically encoded data for each terminal type; a bandwidth estimating unit that estimates the bandwidth of a network used for delivering to a terminal that has sent the content request message; an alteration instructing unit that creates extraction information for extracting at least one hierarchically encoded portion from the received stream or file so as to become compatible with the capability information of the terminal and that instructs the alteration of bit rate and file size so as not to exceed the estimated bandwidth of the network; and a converter that converts the stream or file received from the request destination according to the extraction information and the contents of the instruction.

The content conversion device receives the compression-encoded stream or file requested by a content request message and a terminal via the delivery server 120 receiving a content request message from various types of terminals (the mobile terminal 170 in FIG. 1 is an example of the terminal). The content conversion device (corresponding to the gateway 110 in FIG. 1) reads the capability information of the terminal,which requested the delivery of the content, from the capability information recording unit using the al unit type information included in the content request message. Then, the content conversion device (corresponding to the gateway 110 in FIG. 1) creates the extraction information for extracting at least one hierarchically encoded portion from the received stream or file based on the read capability information. Next, according to the extraction information, the content conversion device (corresponding to the gateway 110 FIG. 1) extracts a hierarchically encoded portion from the stream or file received from the request destination, and performs conversion corresponding to the capability of the terminal and the estimated network bandwidth. The converted stream or file is delivered to the requesting terminal (corresponding to the mobile terminal 170 in FIG. 1), for instance, via the delivery server 120.

With the configuration above, it becomes possible to deliver contents to a variety of terminals from mobile telephones to televisions and to reduce image degradation due to variation in network bandwidth without changing the specifications of the terminals or converting the contents beforehand. Further, as necessary, the protocol or file format can be converted after at least one hierarchically encoded portion has been extracted from the compression-encoded stream or file.

### Exemplary Embodiment 5

Next, the fifth exemplary embodiment of the present invention will be described with a focus on differences from the first to the fourth exemplary embodiments described above.

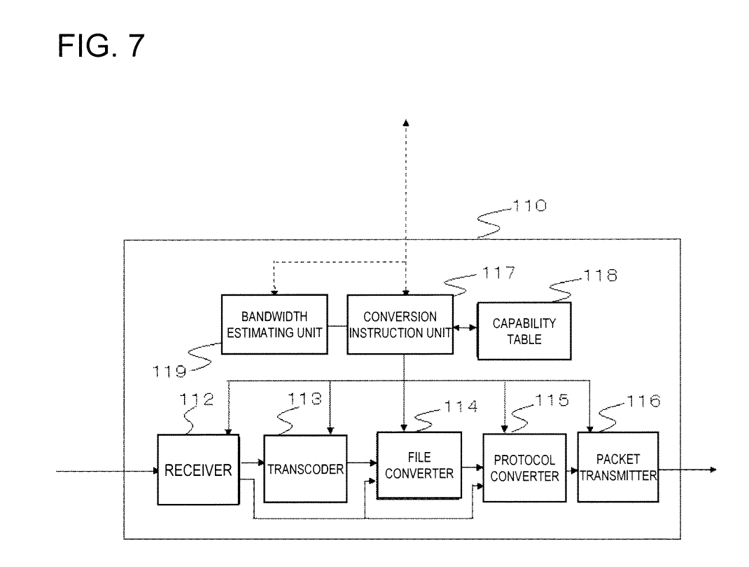

FIG. 7 is a block diagram showing a detailed configuration of a gateway 110 functioning as the content conversion device. With reference to FIG. 7, the gateway 110 comprises the receiver 112, the transcoder 113, the file converter 114, the protocol converter 115, the packet transmitter 116, the conversion instruction unit 117, the capability table 118 corresponding to the capability information recording unit described above, and a bandwidth estimating unit 119.

From the mobile terminal 170, the conversion instruction unit 117 receives a content request message and a response using a particular protocol via the delivery server 120. For instance, in a case of HTTP, terminal unit type information described in the User Agent header can be acquired. In addition, the conversion instruction unit 117 may acquire information (for instance, the type of the network, the bandwidth, etc.) of the network used for the connection. Further, any other known protocols such as SDP (Session Description Protocol) may be used, instead of HTTP.

The following capability information for each type of terminal is held in the capability table 118 in advance.
(1) Receivable codec
(2) Possibility of receiving hierarchically encoded stream or file (yes or no)
(3-1) Receivable level of hierarchically encoded stream (when it is possible to receive hierarchically encoded stream or file)
(3-2) Receivable resolution, bit rate, frame rate (when it is not possible to receive hierarchically encoded stream or file)
(4) Receivable protocol
(5) Receivable file format and file size
   Information other than (1) to (5) above may be added to the capability information.

The bandwidth estimating unit 119 estimates the bandwidth of the mobile network 140 based on the response from the mobile terminal 170 via the delivery server 120.

For instance, an estimated value Wj of the bandwidth at a time j can be calculated using the following expressions using the response message from the mobile terminal 170.

Δj=ACK(j)−ACK(j-1) (1)

Wj=R/Δj (2)

Note that ACK(j) denotes a response message received at the time j, and ACK(j-1) denotes a response message received at a time j-1, which goes back in time by one unit from the time j, in Expressions (1) and (2). Δj in Expression (1) denotes the difference in time of receipt of the response messages at the time j, and R denotes the amount of a bit stream per unit time delivered at the time j-1 or the file size per unit time delivered.

The bandwidth estimating unit 119 calculates and outputs the estimated value Wj of the bandwidth of the mobile network 140 at every predetermined time to the conversion instruction unit 117.

Based on the capability information corresponding to the terminal unit type information read from the capability table 118 above and the capability information (for instance, the codec used when the content was compression-encoded, the screen resolution of the video, bit rate, frame rate, information indicating whether the content is a stream or file, etc.) of the content sent by the delivery server 120, the conversion instruction unit 117 creates the extraction information indicating whether or not the video content received from the delivery server 120 needs to be converted, and what kind of conversion is performed by the transcoder 113 when conversion is necessary.

Further, the conversion instruction unit 117 receives the estimated value Wj of the bandwidth outputted from the bandwidth estimating unit 119 and determines the delivery bit rate or file size so as not to exceed the estimated value Wj of the bandwidth.

For instance, we will assume that the capability information of the content indicates a case where a video content is compression-encoded with H.264/AVC SVC at 10 Mbps having a single Basement Layer, N layers of Enhancement Layers (N is an integer equal to or greater than 1), a maximum resolution of 1440×1080 pixels (HD) with a frame rate of 30 fps, and a minimum resolution of 176×144 (QCIF) with a frame rate of 15 fps.

For instance, we will further assume that the mobile terminal 170 is a new type of mobile telephone and the capability information indicating H.264/AVC SVC encoding at 512 kbps, a screen resolution of QVGA (320×240 pixels), and a frame rate of 30 fps is obtained from the capability table 118.

In this case, the conversion instruction unit 117 creates the extraction information (for instance, converting the screen resolution from HD to QVGA by taking out the Basement Layer bit stream and Enhancement Layer1 from the H.264/AVC SVC bit stream and converting the bit rate and frame rate to 512 kbps and 30 fps, respectively) for extracting at least one hierarchically encoded portion from the H.264/AVC SVC bit stream so that the selected content becomes compatible with the capability information of the terminal at a delivery destination. Further, when the estimated value Wj of the bandwidth is 384 kbps and the capability information of the terminal indicates 512 kbps, the conversion instruction unit 117 determines that the bit rate will exceed the bandwidth of the network if the delivery is made without any changes, further determines that the bit rate and the frame rate should be suppressed at 384 kbps and 30 fps, and outputs this extraction information and these decisions to the transcoder 113. Further, the read capability information is outputted to the receiver 112, the file converter 114, the protocol converter 115, and the packet transmitter 116.

Further, for instance, in a case where the capability information indicates that the terminal unit type information of the mobile terminal 170 indicates an old model, H.264/AVC SVC encoding cannot he decoded, and only MPEG-4 baseband Profile (128 kbps, 15 fps) can he decoded, the conversion instruction unit 117 makes a decision that only Basement Layer is extracted from the H.264/AVC SVC stream and the codec of this is converted into MPEG-4 Baseband Profile (128 kbps, 15 fps) as the extraction information and the conversion information. Since the estimated value Wj of the bandwidth indicates 512 kbps, the conversion instruction unit 117 determines that the bit rate and frame rate of 128 kbps and 15 fps will not exceed the bandwidth, and outputs the contents of the decisions to the transcoder 113. Further, the read capability information is outputted to the receiver 112, the file converter 114, the protocol converter 115, and the packet transmitter 116.

The receiver 112 receives the file or stream of the selected video content from the delivery server 120, extracts the stream stored in the file when it is a file, and outputs the stream. When it is a stream, the receiver 112 extracts a stream stored in the payload of a packet and outputs the stream to the transcoder 113.

The transcoder 113 receives the stream extracted by the receiver 112, has the transcoder, which operates in real time, operate according to the extraction information (for instance, taking out the Basement Layer bit stream and Enhancement Layer1 from the H.264/AVC SVC bit stream) outputted from the conversion instruction unit 117 and the instruction that the bit rate and the frame rate should be suppressed at 384 kbps and 30 fps, extracts at least one hierarchically encoded portion from the H.264/AVC SVC stream, and outputs the extracted stream to the file converter 114.

Meanwhile, when the codec must be converted in the case of an old mobile terminal model, the conversion information is outputted, in addition to the extraction information. In this case, the transcoder 113 extracts, for instance, only Basement Layer from the H.264/AVC SVC stream according to the extraction information, performs codec conversion in which Basement layer is converted into MPEG-4 Baseband Profile (128 kbps, 15 fps), and outputs the converted stream to the file converter 114.

The file converter 114 converts the file format of the extracted stream outputted from the transcoder 113 into a file format to be sent to the mobile terminal 170 according to “(5) Receivable file format and file size” of the capability information of the mobile terminal 170 outputted from the conversion instruction unit 117. For instance, file formats of mobile terminals are 3GPP, 3GPP2, and MP4, and the file format can be determined depending on the model of the mobile terminal. The file converter 114 generates a file according to the file format determined as described, stores the extracted stream therein, and outputs the file to the protocol converter 115. As for the details of the 3GPP file format, one can refer to the 3GPP TS 26.244 standard.

The protocol converter 115 determines a protocol receivable by the mobile terminal 170 according to “(4) Receivable protocol” of the capability information outputted from the conversion instruction unit 117, and sends the file outputted from the file converter 114 via this protocol. Here, HTTP is used as the protocol, however, other known protocols such as RTP (Real-time Transport Protocol) may be used.

The packet transmitter 116 sends the file outputted from the protocol converter 115 as an HTTP/UDP/IP packet to the mobile network 140 according to the capability information outputted from the conversion instruction unit 117. Here, other known packet formats such as the RTP/UDP/IP packet may be used as the packet format used by the packet transmitter 116 to send the packet.

In the fifth exemplary embodiment of the present invention described above, the mobile network 140 may be a WiMax network or LTE network, instead of a mobile packet network, and the same configuration can be used. Further, a network using a femtocell access point may be used with the same configuration as well.

Further, in the exemplary embodiment described above, 3GPP, 3GPP2, and MP4 are cited as examples of the conversion destination mat of the file converter 114, however, other file formats may be used.

Further, in the exemplary embodiment described above, HTTP and RTP are cited as examples of the conversion destination protocol of the protocol converter 115, however, other protocols may be used.

Further, in the exemplary embodiment described above, the content obtained by compression-encoding a video signal is delivered, however, the same configuration may be applied to contents such as still images, audio signals, and voice signals.

As described, according to the present invention, since the gateway 110 automatically extracts a hierarchically encoded portion by creating a stream including a plurality of hierarchically encoded portions for each video content, the need for editing work in advance considering the capability of a terminal at a delivery destination and the modification of the terminal is eliminated, and it becomes possible for any terminal to play back a stream received. Further, in the case where the bandwidth estimating unit 119 is provide as in the fifth exemplary embodiment, image degradation due to variation in network bandwidth can be reduced.

Because of the above, the present invention has a great advantage over Patent Document 1. In other words, in Patent Document 1, the requested data aspect identifying information showing the aspect of hierarchically encoded data requested by a client must be stored in a request message from the client to the server and transmitted therewith, and it is necessary to modify the client so that it is able to send the requested data aspect identifying information or newly bring in a client comprising such a function. According to the present invention, however, the modification of the client and terminal is unnecessary, and conventional clients and terminals can be used without any changes.

The exemplary embodiments of the present invention have been described above, however, the present invention is not limited to the above exemplary embodiments and further modifications, replacements, and adjustments can be added within the scope of the basic technological concept of the present invention. For instance, in the exemplary embodiments described above, the content obtained by compression-encoding a video signal is delivered, however, the same configuration may be applied to contents such as still images and audio signals.

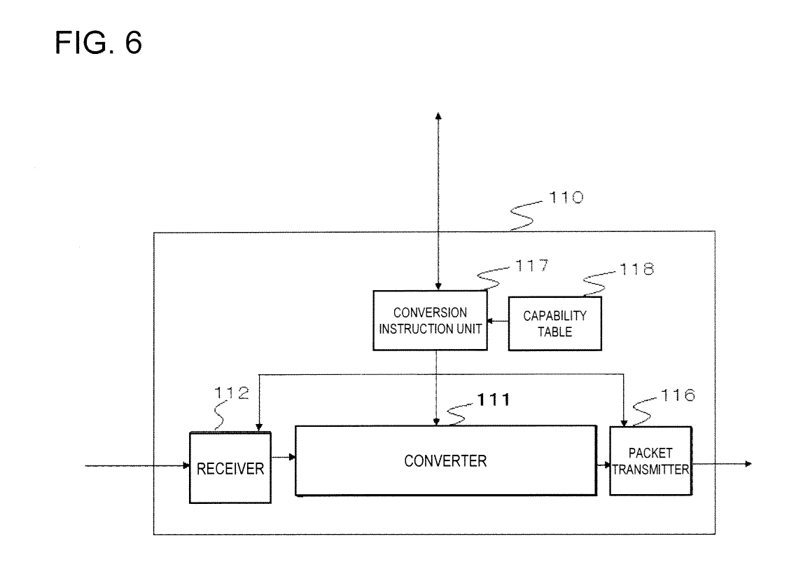

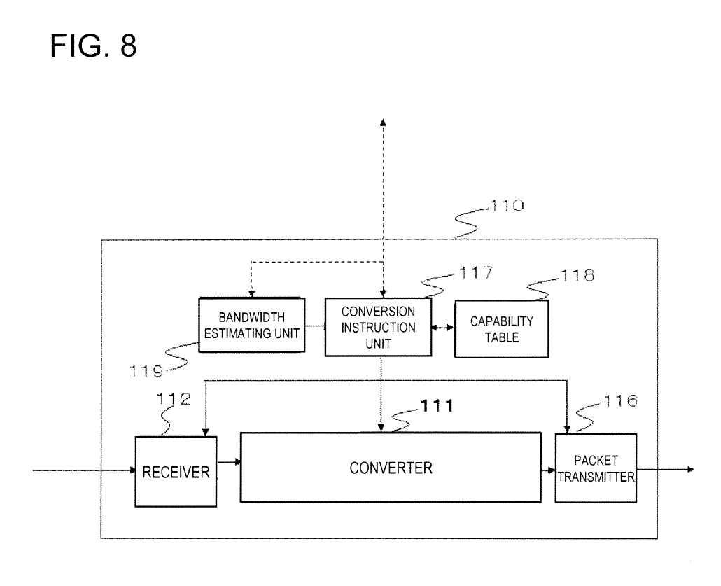

Further, in the exemplary embodiments above, the gateway 110 comprises the file converter 114 and the protocol converter 115, however, when the file conversion and the protocol conversion are unnecessary, a configuration performing conversion processing using the extraction information and omitting the file conversion and the protocol conversion as shown in FIGS. 6 and 8 may be employed.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

Finally, preferred modes of the present invention will be summarized.

### [Mode 1]

### (Refer to the Delivery System According to the First Aspect.)

### [Mode 2]

The delivery system in Mode 1, wherein the content conversion device converts the protocol or file format of the extracted hierarchically encoded portion based on the capability information.

### [Mode 3]

The delivery system in Mode 1 or 2, wherein the content conversion device extracts at least one hierarchically encoded portion from the received stream or file and converts the codec thereof into a codec receivable by the terminal based on the capability information of the terminal read from the capability information recording unit when the terminal is unable to receive hierarchically encoded data.

### [Mode 4]

The delivery system in any one of Modes 1 to 3 including the H.264/AVC SVC method as a method for hierarchically encoding a video signal.

### [Mode 5]

The delivery system in any one of Modes 1 to 4, wherein the capability table includes the capability information of at least two types of the following devices: mobile telephone, personal computer, game terminal, digital photo frame, set-top box, home gateway, and television.

### [Mode 6]

The delivery system in any one of Modes 1 to 5 further comprising a delivery server relaying between the content conversion device and the terminal.

### [Mode 7]

The delivery system in any one of Modes 1 to 6, wherein the network is any one of the following networks: IP (Internet Protocol) network, broadband network, NGN (Next Generation Network), the Internet network, W-LAN (Wireless Local Area Network), mobile packet network, WiMax (Worldwide Interoperability for Microwave Access) network, and LTE (Long Term Evolution) network.

### [Mode 8]

### (Refer to the Content Conversion Device According to the Second Aspect.)

### [Mode 9]

### (Refer to the Delivery Method According to the Third Aspect.)

### [Mode 10]

### (Refer to the Program According to the Fourth Aspect.)

### [Mode 11]

A delivery system including a content conversion device comprising:
a capability information recording unit that associates and records terminal unit type information included in a content request message with capability information regarding the capability of a terminal to receive hierarchically encoded data;
a receiver that receives a stream or file compression-encoded by means of a hierarchical encoding method based on the content request message;
a bandwidth estimating unit that estimates the bandwidth of a network used for delivering to the terminal that has sent the content request message;
an alteration instructing unit that creates extraction information for extracting at least one hierarchically encoded portion from the received stream or file based on the terminal capability information corresponding to the terminal unit type information included in the content request message;
a converter that converts the stream or received from the request destination according to the extraction information;
a packet transmitter that transmits converted stream or file; and
the alteration instructing unit instructs the converter not to exceed the bandwidth of the network estimated by the bandwidth estimating unit.

### [Mode 12]

The delivery system in Mode 11, wherein the content conversion device converts the protocol or file format of the extracted hierarchically encoded portion based on the capability information.

### [Mode 13]

The delivery system in Mode 11 or 12, wherein the content conversion device extracts at least one hierarchically encoded portion from the received stream or file and converts the codec thereof into a codec receivable by the terminal based on the capability information of the terminal read from the capability information recording unit when the terminal is unable to receive hierarchically encoded data.

### [Mode 14]

The delivery system in any one of Modes 11 to 13, wherein the bandwidth estimating unit estimates the bandwidth of a network used for delivery using response information from a terminal at a delivery destination.

### [Mode 15]

The delivery system in any one of Modes 11 to 14 including the H.264/AVC SVC method as a method for hierarchically encoding a video signal.

### [Mode 16]

The delivery system in any one of Modes 11 to 15, wherein the capability table includes the capability information of at least two types of the following devices: mobile telephone, personal computer, game terminal, digital photo frame, set-top box, home gateway, and television.

### [Mode 17]

The delivery system in any one of Modes 11 to 16 further comprising a delivery server relaying between the content conversion device and the terminal.

### [Mode 18]

The delivery system in any one of Modes 11 to 17, wherein the network is any one of the following networks: IP (Internet Protocol) network, broadband network, NGN (Next Generation Network), the Internet network, W-LAN (Wireless Local Area Network), mobile packet network, WiMax (Worldwide Interoperability for Microwave Access) network, and LTE (Long Term Evolution) network.

### [Mode 19]

A content conversion device comprising:
a capability information recording unit that associates and records terminal unit type information included in a content request message with capability information regarding the capability of a terminal to receive hierarchically encoded data;
a receiver that receives a stream or file compression-encoded by means of a hierarchical encoding method based on the content request message;
a bandwidth estimating unit that estimates the bandwidth of a network used for delivering to the terminal that has sent the content request message;
an alteration instructing unit that creates extraction information for extracting at least one hierarchically encoded portion from the received stream or file based on the terminal capability information corresponding to the terminal unit type information included in the content request message;
a converter that converts the stream or file received from the request destination according to the extraction information;
a packet transmitter that transmits the converted stream or file; and
the alteration instructing unit that instructs the converter not to exceed the bandwidth of the network estimated by the bandwidth estimating unit.

### [Mode 20]

A delivery method including:
a step of receiving a stream or file compression-encoded by means of a hierarchical encoding method based on a content request message;
a step of estimating the bandwidth of a network used for delivering to a terminal that has sent the content request message;
a step of creating extraction information for extracting at least one hierarchically encoded portion from the received stream or file based on capability information regarding the capability of a terminal to receive hierarchically encoded data derived from unit type information of the terminal included in the content request message;
a step of converting the stream or file received from the request destination according to the extraction information; and
a step of delivering the converted stream or file to the terminal; wherein
the delivery is made after the conversion is performed so as not to exceed the estimated network bandwidth in the converting step.

### [Mode 21]

A program executed by a computer converting content delivered to a terminal in response to an external request, having the computer execute:
a process of receiving a stream or file compression-encoded by means of a hierarchical encoding method from a content delivery source based on a content request message from the terminal;
a process of estimating the bandwidth of a network used for delivering to the terminal that has sent the content request message;
a process of creating extraction information for extracting at least one hierarchically encoded portion from the received stream or file based on capability information regarding the capability of the terminal to receive hierarchically encoded data derived from terminal unit type information included in the content request message;
a process of converting the stream or file received from the request destination according to the extraction information; and
a process of outputting the converted stream or file to the terminal; and
having the computer convert the stream or file so as not to exceed the estimated network bandwidth in the process of converting the stream or file.

### EXPLANATIONS OF SYMBOLS

100: content providing device
110: gateway (content conversion device)
112: receiver
113: transcoder
114: file converter
115: protocol converter
116: packet transmitter
117: conversion instruction unit
118: capability table (capability information recording unit)
119: bandwidth estimating unit
120: delivery server
130: first network
140, 150: mobile network
160: second network (Internet)
170: mobile terminal
180: PC (personal computer)
190: game terminal
195: xGSN device
196: RNC device

What is claimed is:

1. A delivery system including a content conversion device comprising:
a capability information recording unit that associates and records terminal unit type information included in a content request message with capability information regarding the capability of a terminal to receive hierarchically encoded data;
a receiver that receives a stream or file compression-encoded by means of a hierarchical encoding method based on said content request message;
an alteration instructing unit that creates extraction information for extracting at least one hierarchically encoded portion from said received stream or file based on the terminal capability information corresponding to the terminal unit type information included in a content request message;
a converter that converts said stream or file received from said request destination according to said extraction information; and
a packet transmitter that transmits said converted stream or file.

2. The delivery system as defined in claim 1, wherein said content conversion device converts the protocol or file format of said extracted hierarchically encoded portion based on said capability information.

3. The delivery system as defined in claim 1, wherein said content conversion device extracts at least one hierarchically encoded portion from said received stream or file and converts the codec thereof into a codec receivable by said terminal based on the capability information of said terminal read from said capability information recording unit when said terminal is unable to receive hierarchically encoded data.

4. The delivery system as defined in claim 1 including the H.264/AVC SVC method as a method for hierarchically encoding a video signal.

5. The delivery system as defined in claim 1, wherein said capability table includes the capability information of at least two types of the following devices: mobile telephone, personal computer, game terminal, digital photo frame, set-top box, home gateway, and television.

6. The delivery system as defined in claim 1 further comprising a delivery server relaying between said content conversion device and said terminal.

7. The delivery system as defined in claim 1, wherein said network is any one of the following networks: IP (Internet Protocol) network, broadband network, NGN (Next Generation Network), the Internet network, W-LAN (Wireless Local Area Network), mobile packet network, WiMax (Worldwide Interoperability for Microwave Access) network, and LTE (Long Term Evolution) network.

8. The delivery system as defined in claim 1 including the content conversion device, which further comprises: a bandwidth estimating unit that estimates the bandwidth of a network used for delivering to the terminal that has sent said content request message; and
said alteration instructing unit that instructs said converter not o exceed the bandwidth of the network estimated by said bandwidth estimating unit.

9. The delivery system as defined in claim 8, wherein said content conversion device converts the protocol or file format of said extracted hierarchically encoded portion based on said capability information.

10. A content conversion device comprising:
a capability information recording unit that associates and records terminal unit type information included in a content request message with capability information regarding the capability of a terminal to receive hierarchically encoded data;
a receiver that receives a stream or file compression-encoded by means of a hierarchical encoding method based on said content request message;
an alteration instructing unit that creates extraction information for extracting at least one hierarchically encoded portion from said received stream or file based on the terminal capability information corresponding to the terminal unit type information included in a content request message;
a converter that converts said stream or file received from said request destination according to said extraction information; and
a packet transmitter that transmits said converted stream or file.

11. The content conversion device as defined in claim 10 further comprising:
a bandwidth estimating unit that estimates the bandwidth of a network used for delivering to the terminal that has sent said content request message; and
said alteration instructing unit that instructs said converter not to exceed the bandwidth of the network estimated by said bandwidth estimating unit.

12. A delivery method including:
receiving a stream or file compression-encoded by means of a hierarchical encoding method based on a content request message;
creating extraction information for extracting at least one hierarchically encoded portion from the received stream or file based on capability information regarding the capability of a terminal to receive hierarchically encoded data derived from unit type information of said terminal included in a content request message;
converting said stream or file received from said request destination according to said extraction information; and
delivering said converted stream or file to the transmission source of said content request message.

13. The delivery method as defined in claim 12 further including:
estimating the bandwidth of a network used for delivering to the terminal that has sent said content request message; wherein
the delivery is made after the conversion is performed so as not to exceed said estimated network bandwidth in said converting step.

14-15. (canceled)

16. The delivery system as defined in claim 2, wherein said content conversion device extracts at least one hierarchically encoded portion from said received stream or file and converts the codec thereof into a codec receivable by said terminal based on the capability information of said terminal read from said capability information recording unit when said terminal is unable to receive hierarchically encoded data.

17. The content conversion device as defined in claim 10, wherein the content conversion device converts the protocol or file format of said extracted hierarchically encoded portion based on said capability information.

18. The content conversion device as defined in claim 10, wherein the content conversion device extracts at least one hierarchically encoded portion from said received stream or file and converts the codec thereof into a codec receivable by said terminal based on the capability information of said terminal read from said capability information recording unit when said terminal is unable to receive hierarchically encoded data.

19. The content conversion device as defined in claim 11, wherein the content conversion device converts the protocol or file format of said extracted hierarchically encoded portion based on said capability information.

20. The content conversion device as defined in claim 11, wherein the content conversion device extracts at least one hierarchically encoded portion from said received stream or file and converts the codec thereof into a codec receivable by said terminal based on the capability information of said terminal read from said capability information recording unit when said terminal is unable to receive hierarchically encoded data.

21. The delivery system as defined in claim 2 including the H.264/AVC SVC method as a method for hierarchically encoding a video signal.

22. The delivery system as defined in claim 3 including the H.264/AVC SVC method as a method for hierarchically encoding a video signal.
